(19) United States
(12) Patent Application Publication
(10) Pub. No.: US 2014/0144396 A1
(43) Pub. Date: May 29, 2014

(54) Hand-guided power tool with internal combustion engine

(71) Applicant: Andreas Stihl AG & Co. KG, Waiblingen (DE)

(72) Inventors: Günter Wolf, Oppenweiler (DE); Niels Kunert, Ottenbach (DE); Martin Rieber, Stuttgart (DE); Alexander Kraus, Weinstadt (DE)

(73) Assignee: Andreas Stihl AG & Co. KG, Waiblingen (DE)

(21) Appl. No.: 14/091,889

(22) Filed: Nov. 27, 2013

(30) Foreign Application Priority Data
Nov. 28, 2012 (DE) 10 2012 023 166.0

(51) Int. Cl. F02B 63/02

(52) U.S. Cl. CPC F02B 63/02
USPC 123/2

(57) ABSTRACT

A power tool has an internal combustion engine with a piston supported in the cylinder and delimiting a combustion chamber. A crankshaft is rotatably supported in the crankcase and driven by the piston. Combustion air is supplied to the combustion chamber via an intake passage that has a piston-controlled inlet opening and an intake section formed within the cylinder. The bottom of the intake section, when the cylinder axis is vertical and the crankcase is beneath the combustion chamber, connects lowermost points of passage cross-sections arranged in the intake section perpendicular to the flow direction. The bottom descends toward the crankcase when the longitudinal cylinder axis is vertical. A ramp arranged in the intake passage next to the inlet opening deflects a portion of flow flowing within the intake passage. The ramp, when the longitudinal cylinder axis is vertical, ascends in flow direction toward the crankcase.

### BACKGROUND OF THE INVENTION

The invention relates to a hand-guided power tool with an internal combustion engine that drives at least one tool member of the power tool. The internal combustion engine has a cylinder with a longitudinal cylinder axis wherein the cylinder has a cylinder bore in which the piston is reciprocatingly supported. The piston drives a crankshaft that is rotatably supported about an axis of rotation within the crankcase. The internal combustion engine has an intake passage for supply of combustion air. The intake passage opens through a piston-controlled inlet opening into the crankcase and an intake section of the intake passage is formed within the cylinder. The intake section of the intake passage formed within the cylinder has a bottom. When the longitudinal cylinder axis is vertically positioned and the crankcase is arranged beneath the combustion chamber, the bottom of the intake section of the intake passage formed within the cylinder connects the lowermost points of at least two passage cross-sections that are arranged perpendicular to the flow direction in the intake section of the intake passage. The bottom descends toward the crankcase when the longitudinal cylinder axis is vertically positioned.

US 2005/0045138 A1 discloses an internal combustion engine for a hand-guided power tool. In the disclosed perpendicular arrangement of the longitudinal cylinder axis, the bottom of the piston-controlled intake passage that opens into the crankcase descends toward the crankcase. Accordingly, the fuel/air mixture fed into the intake passage first reaches the crankcase.

U.S. Pat. No. 8,261,701 B1discloses an internal combustion engine in which in the crankcase interior a flow guiding element is arranged which deflects the fuel/air mixture, flowing within the crankcase interior, toward the bottom side of the piston in order to cool the piston in this way.

### SUMMARY OF THE INVENTION

It is an object of the present invention to provide a hand-guided power tool with an internal combustion engine that provides an excellent cooling action of the piston during operation of the internal combustion engine.

In accordance with the present invention, this is achieved in that the internal combustion engine is provided in the intake passage with at least one ramp next to the inlet opening, wherein the at least one ramp deflects at least a portion of the flow flowing within the intake passage and the at least one ramp ascends in the flow direction toward the crankcase at least within the section that adjoins the inlet opening, when the longitudinal cylinder axis is vertically positioned.

Accordingly, it is provided to arrange in the intake passage next to the inlet opening at least one ramp that deflects the flow flowing in the intake passage. The at least one ramp is oriented such that, when the longitudinal cylinder axis is positioned perpendicular, i.e., is vertically arranged, the at least one ramp ascends in the flow direction toward the crankcase at least within the ramp section that is adjoining the inlet opening. In this context, the internal combustion engine is arranged such that the crankcase is arranged beneath the combustion chamber. In this way, the combustion air, which contains preferably fuel and is fed in through the intake passage into the crankcase, is deflected immediately toward the piston after flowing into the interior of the crankcase. In this way, an excellent immediate cooling of the piston and of the piston pin is achieved. At the same time, a simple configuration results because the ramp arranged within the intake passage can be formed monolithically with the cylinder and, accordingly, can be produced in a simple way. In contrast to the flow guiding elements which are arranged within the interior of the crankcase, the piston movement and movement of the crankshaft must not be taken into account when the ramp is located within the intake passage.

Advantageously, the power tool has a customary or conventional park or rest position in which the power tool is placed on a flat horizontal support surface. In the park position, the longitudinal cylinder axis is positioned relative to the support surface at an angle that is approximately 60° to approximately 90°. The cylinder is therefore arranged upright or at a slight slant within the power tool.

In particular in case of power tools whose internal combustion engine is arranged upright or arranged at a slight slant, the intake passage usually extends in descending orientation toward the crankcase for a vertically arranged longitudinal cylinder axis. Advantageously, the intake passage in the flow direction toward the crankcase does not ascend but is horizontal or descending.

In this way, it is achieved that fuel which deposits within the intake passage can drain toward the crankcase. This is achieved in case of horizontal orientation of the bottom of the intake passage due to the flow flowing within the intake passage. Advantageously, the angle at which the bottom is positioned relative to the support surface when the combustion engine is in the park position is approximately 0° to approximately 30°. For such an orientation of the intake passage, the combustion air fed into the intake passage or the fuel/air mixture fed into the intake passage is supplied immediately into the area of the crankshaft within the interior of the crankcase. Therefore, fuel/air mixture that reaches the piston and the piston pin has disadvantageously already been heated in the area of the crankshaft.

As a result of the arrangement of the ramp in the intake passage in accordance with the invention, the incoming combustion air or the incoming fuel/air mixture can be deflected immediately after entering the crankcase at least partially to the piston and to the piston pin and can contribute thereby to an efficient cooling action.

The piston is advantageously connected by means of a piston pin with a connecting rod wherein the piston pin has a longitudinal axis. The ramp has at the inlet opening a top edge wherein the imaginary tangential extension of the ramp at the top edge intersects the longitudinal cylinder axis at a point of intersection. The spacing of the point of intersection to the longitudinal axis of the piston pin is at top dead center of the piston at most approximately 30%, in particular less than approximately 20%, of the diameter of the piston. The combustion air or the fuel/air mixture inflowing through the intake passage and deflected by the ramp is therefore deflected by the ramp in the direction of the area of the piston pin. At top dead center of the piston, the point of intersection is advantageously between the axis of rotation of the crankshaft and the longitudinal axis of the piston pin. The point of intersection is therefore located at top dead center of the piston at the side of the piston pin which is facing the crankcase.

The piston pin is supported advantageously by a bearing within the connecting rod. The combustion air which is deflected by the ramp cools the bearing of the piston pin. Advantageously, the supplied combustion air contains fuel and lubricant oil. The combustion air which is deflected by the ramp transports the lubricant oil to the bearing of the piston pin. In this way, a reliable lubrication action of the bearing of the piston pin in operation of the combustion engine can be ensured in a simple way.

Advantageously, in the position of the piston in which the inlet opening begins to open, the spacing of the point of intersection of the longitudinal axis of the piston pin is also less than approximately 30% of the diameter of the piston. In this position, the inflowing combustion air or the inflowing fuel/air mixture is accordingly deflected approximately in the direction toward the piston pin. In this way, during the entire opening period of the inlet opening, the inflowing fuel/air mixture or the inflowing combustion air is deflected at least partially in the direction toward the piston pin. In the position of the piston in which the inlet opening begins to open, the point of intersection is advantageously between the longitudinal axis of the piston pin and the combustion chamber. As the inlet opening begins to open, the combustion air is therefore deflected in the direction toward an area above the piston pin, i.e., an area between the piston pin and the piston bottom. Upon further upward stroke of the piston, the flow is further deflected in the direction toward the piston pin until, at top dead center of the piston, the flow is substantially flowing in the direction toward an area somewhat below the piston pin, i.e., between piston pin and axis of rotation of the crankshaft.

Advantageously, the total width of the ramp, measured in circumferential direction of the piston and the cylinder bore, is matched to the width of the connecting rod measured parallel to the axis of rotation of the crankshaft. The total width of the ramp is measured in a section plane that is perpendicular to the longitudinal cylinder axis. The total width of the ramp is advantageously at least approximately 80% of the width of the connecting rod in a bearing section that surrounds the piston pin. Advantageously, the total width of the ramp is less than approximately 150% of the width of the connecting rod in the bearing section that surrounds the piston pin. In particular, the total width of the ramp is smaller than the width of the inlet opening. The width of the inlet opening in this context is also measured in the circumferential direction of the cylinder bore, i.e., in a section plane that extends perpendicularly to the longitudinal cylinder axis. The total width of the ramp is advantageously less than approximately 80% of the width of the inlet opening that is measured perpendicular to the longitudinal cylinder axis. In this way, a portion of the incoming combustion air or of the incoming fuel/air mixture is flowing in immediately in the direction of the crankshaft. In the area of the connecting rod where a particularly good cooling action must be achieved because of the bearing for the piston pin, the combustion air flows out of the intake passage immediately to the piston pin.

Advantageously, the inlet opening is opened first at the top edge of the ramp upon upward stroke of the piston. Areas that are laterally arranged relative to the top edge of the ramp are advantageously opened somewhat later. In this way, a particularly good cooling action of the piston pin is achieved. An appropriate control action of the inlet opening can be achieved in a simple way in that the piston has a control edge in the area controlling the top edge, wherein the control edge is provided with a spacing relative to the piston rim that is facing the crankcase that is greater than the height of the ramp measured parallel to the longitudinal cylinder axis at the top edge.

In order to ensure that no fuel will collect at the at least one ramp, it is provided that a drain for fuel is opening at the inlet opening, wherein the drain in the park position descends toward the crankcase. Advantageously, such a drain is formed at both sides of the at least one ramp, respectively. In this context, the ramp extends advantageously only across a portion of the width of the inlet opening. The drain extends advantageously along an imaginary extension of the bottom of the intake passage. However, it can also be provided that the drain is a passage, for example, configured as a bore that extends through the ramp. In this case, the ramp can extend across the entire width of the inlet opening. It can also be provided that the ramp itself forms a drain when the combustion engine is arranged such that the ramp in the park position is descending toward the crankcase.

Advantageously, several ramps are arranged in the intake passage next to the inlet opening. In this way, the number of drains can be increased. The proportion of combustion air or fuel/air mixture that is supplied directly into the crankcase is increased. By suitable selection of the number of ramps, an excellent cooling action and lubrication of the crankshaft as well as an excellent cooling action and lubrication of the piston pin bearing can be achieved. Advantageously, a drain is arranged on both sides of each one of the ramps, respectively. The ramps are advantageously arranged such that an excellent cooling action and lubrication of the bearing of the piston pin is achieved.

### BRIEF DESCRIPTION OF THE DRAWING

FIG. 1 is a schematic illustration of a motor chainsaw with a first arrangement of the internal combustion engine.

FIG. 2 is a schematic illustration of a motor chainsaw with a second arrangement of the internal combustion engine.

FIG. 3 is a section view of the internal combustion engine of FIG. 1 as the inlet opening begins to open.

FIG. 4 is a detail section illustration of the internal combustion engine with partially open inlet opening.

FIG. 5 is a perspective section illustration of the internal combustion engine in the area of the inlet opening in the position of the piston as shown in FIG. 4.

FIG. 6 is another perspective section illustration of the internal combustion engine in the area of the inlet opening in the position of the piston as shown in FIG. 4.

FIG. 7 is a detail section illustration of the internal combustion engine with completely opened inlet opening.

FIG. 8 is a detail section illustration of the internal combustion engine at top dead center of the piston.

FIG. 9 is a perspective illustration of the inlet opening in the direction of arrow IX of FIG. 8.

FIG. 10 is a perspective illustration of the inlet opening in the direction of arrow X of FIG. 8.

FIG. 11 is a side view of the inlet opening in the direction of arrow XI of FIG. 8.

FIG. 12 is a side view of the piston in the direction of arrow XII in FIG. 8.

FIG. 13 is a section view along the section line XIII-XIII of FIG. 11.

FIG. 14 is a section view along the section line XIV-XIV of FIG. 11.

FIG. 15 is a detail section illustration of an embodiment of the internal combustion engine.

FIG. 16 shows the area of the ramp of FIG. 15 in detail illustration.

FIG. 17 is a perspective illustration of the inlet opening in the direction of arrow XVII of FIG. 15.

FIG. 18 is a detail section illustration of a further embodiment of the internal combustion engine.

FIG. 19 is a perspective illustration of the inlet opening in the direction of arrow XIX of FIG. 18.

FIG. 20 is a detail section illustration of the area of the ramp of FIG. 18.

FIG. 21 is a detail section illustration of a further embodiment of a cylinder of an internal combustion engine.

FIG. 22 is a side view of a piston for the cylinder of FIG. 21.

FIG. 23 is a section view along the section line XIII-XIII of FIG. 21.

FIG. 24 is a section view along the section line XXIV-XXIV of FIG. 21.

FIG. 25 is a section view along the section line XXV-XXV of FIG. 24.

### DESCRIPTION OF THE PREFERRED EMBODIMENTS

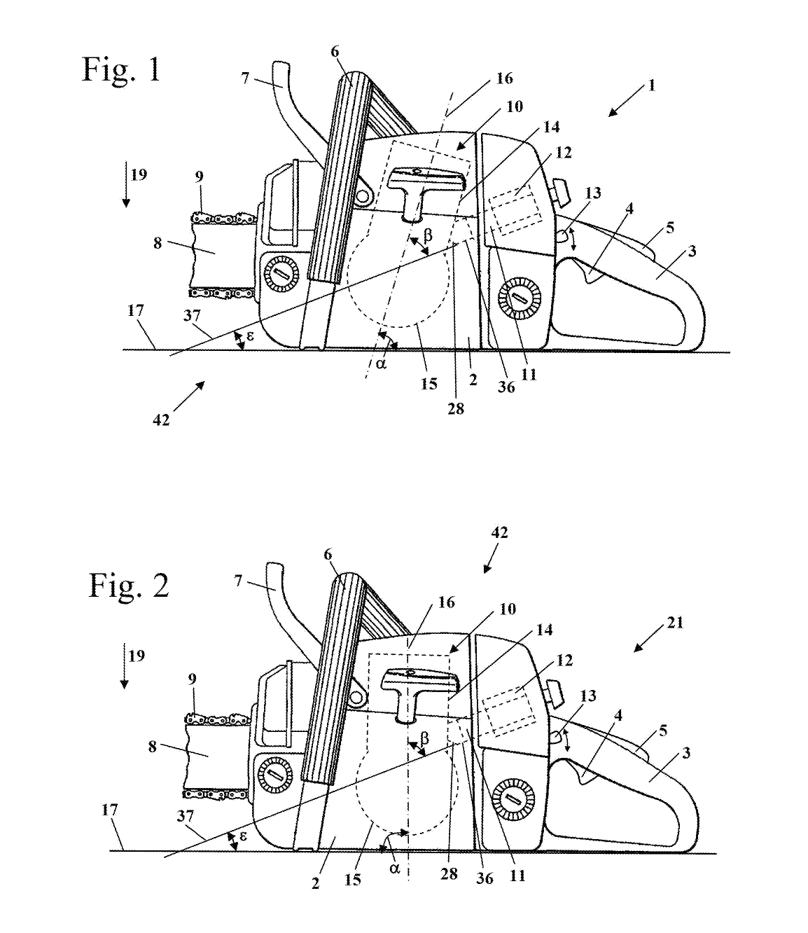

FIG. 1 shows a motor chainsaw 1 as an embodiment of a hand-guided power tool. The present invention can however also be used in connection with other hand-guided power tools with an internal combustion engine, for example, a cut-off machine, a trimmer, a blower or the like. In case of a blower, the fan wheel that conveys the working air stream is considered the tool member.

The motor chainsaw 1 has a housing 2 on which the rear handle 3 as well as the grip pipe 6 for guiding the motor chainsaw 1 in operation are secured. On the rear handle 3, a throttle trigger 4 and a throttle trigger lock 5 are arranged. Adjacent to the rear handle 3, an operating mode selector 13 projects from the housing 2 of the motor chainsaw 1. The motor chainsaw 1 has a guide bar 8 that projects in forward direction from the side of the housing 2 opposite the rear handle 3. A saw chain 9 is arranged so as to circulate about the guide bar 8. The saw chain 9 that constitutes the tool member of the motor chainsaw 1 is driven by an internal combustion engine 10 that is arranged in the housing 2. On the side of the grip pipe 6 which is facing the guide bar 8, a hand guard 7 is arranged which can serve for triggering a braking device (not illustrated) for the saw chain

In the illustration of FIG. 1, the motor chainsaw 1 is placed (parked) on a flat horizontal support surface 17. The housing 2 may be resting on the support surface 17. In the shown embodiment, the motor chainsaw 1 is contacting the support surface 17 with the rear handle 3 as well as with the lower section of the grip pipe 6. The force of gravity is acting in the direction of action 19 perpendicularly on the support surface 17. In the state resting on the support surface 17, the motor chainsaw 1 is in a rest position or park position 42.

The internal combustion engine 10 comprises a cylinder 14 with a longitudinal cylinder axis 16 and further comprises a crankcase 15. The longitudinal cylinder axis 16 is slanted relative to the support surface 17 at an angle α which is approximately 60° to approximately 90°. In the illustrated embodiment of FIG. 1, the angle α is smaller than 90° and is advantageously approximately 70°.

For supplying combustion air and fuel, the internal combustion engine 10 has an intake passage 11 that opens into the crankcase 15. An intake section of the intake passage 11 is formed in a carburetor 12 in which fuel is fed into the sucked-in combustion air. The fuel contains lubricant oil for lubricating the moving parts in the crankcase 15. It is also possible to supply fuel by means of a fuel valve. However, it can be provided also that only combustion air is supplied by means of the intake passage 11 while fuel is directly supplied by means of a separate fuel valve into the crankcase or into a combustion chamber formed within the cylinder 14.

As shown in FIG. 1, the intake passage 11 has a bottom 36 whose imaginary tangential extension 37 is positioned relative to the support surface 17 at an angle ε. The angle ε is smaller than 90° and is advantageously 0° to approximately 30°. The angle ε is selected such that the bottom 36 in the flow direction toward the crankcase 15 does not ascend. The bottom 36 of the intake passage 11 descends advantageously in flow direction toward the interior of the crankcase 15 in the illustrated park position 42 of the motor chainsaw 1 shown in FIG. 1. In this way, it is ensured that fuel which deposits on the walls of the intake passage 11 and collects in the area of the bottom 36 of the intake passage 11 can drain toward the crankcase interior in the rest position 42. In particular, the angle ε is greater than 5°, advantageously greater than 10°. In the intake passage 11 there is also a ramp 28 which will be explained in more detail in the following.

FIG. 2 shows an embodiment of the motor chainsaw 21 whose configuration is substantially the same as that of motor chainsaw 1 of FIG. 1. Same reference characters identify the same elements as in FIG. 1. The motor chainsaw 21 differs from the motor chainsaw 1 of FIG. 1 only in respect to the orientation of the internal combustion engine 10 within the housing 2. The longitudinal cylinder axis 16 of the motor chainsaw 21 is positioned relative to the support surface 17 at an angle α that is approximately 90° The longitudinal cylinder axis 16 is therefore perpendicular to the support surface 17 and is aligned with the direction of action 19 of the force of gravity. The longitudinal cylinder axis 16 is thus vertically positioned. The bottom 36 of the intake passage 11 is positioned relative to the support surface 17 at an angle ε which corresponds to the angle ε illustrated in FIG. 1.

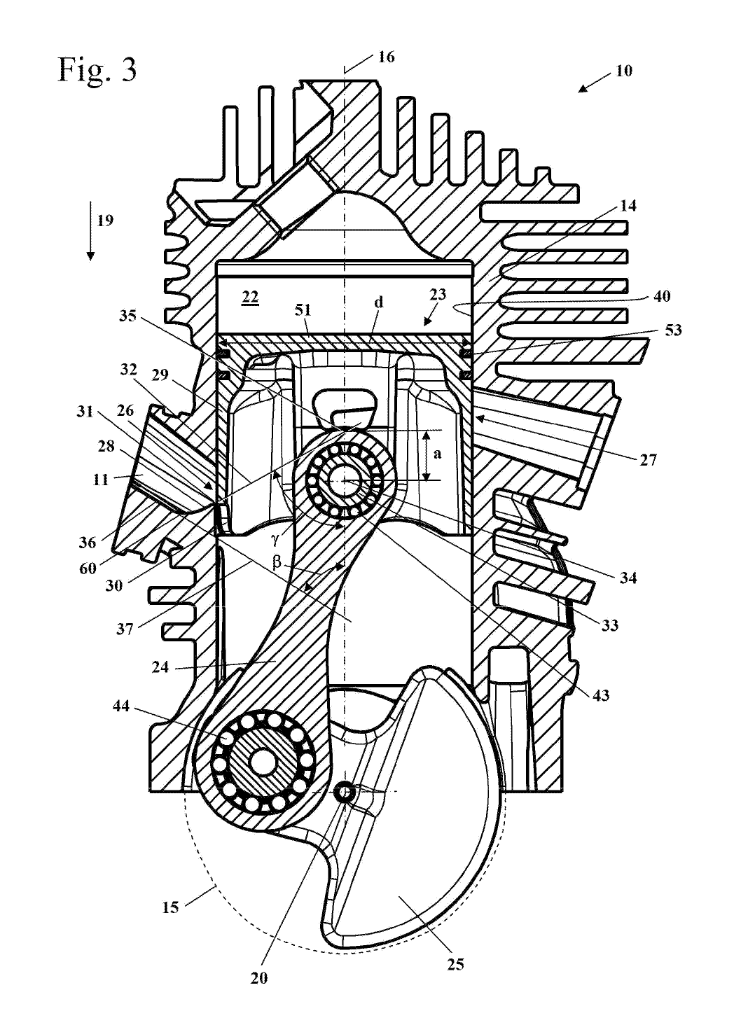

FIG. 3 shows the configuration of the internal combustion engine 10 in detail. The internal combustion engine 10 is designed as a two-stroke engine and has a cylinder 14 with a cylinder bore 40. The longitudinal cylinder axis 16 is the center axis of the cylinder bore 40 in the direction of length. In the cylinder bore 40 a piston 23 is reciprocatingly supported. The piston 23 drives by means of connecting rod 24 a crankshaft 25 which is rotatably supported about axis of rotation 20 within the crankcase 15. The internal combustion engine 10 has transfer passages 64 that are partially shown in FIG. 21 and by means of which the interior of the crankcase 15 in the position of bottom dead center of the piston 23 is connected with combustion chamber 22. After it has entered the crankcase 1, the fuel/air mixture is compressed upon downward stroke of the piston 23 and, when the piston 23 is at or near bottom dead center, is forced through the transfer passages 64 into the combustion chamber 22. During the subsequent upward stroke of the piston 23, the fuel/air mixture in the combustion chamber 22 is compressed and ignited when the piston 23 is at or near top dead center. The combustion of the fuel/air mixture in the combustion chamber 22 accelerates the piston 23 in the direction toward the crankcase 15.

The connecting rod 24 is supported with a first bearing 43 on a piston pin 33 which is secured on the piston 23. The piston pin 23 has a longitudinal axis 34. At its opposite end, the connecting rod 24 is supported with a second bearing 44 on crankshaft 25. The crankshaft 25 is rotatably supported in the crankcase 15 about axis of rotation 28 and is driven in rotation by piston 23 by means of the connecting rod 24 about the axis of rotation 28.

The piston 23 has a piston bottom 51 which delimits the combustion chamber 22. A spark plug, not shown in FIG. 3, projects into the combustion chamber 22. A piston-controlled outlet opening 27 controlled by piston 23 and outlet passage lead away from the combustion chamber 22. The intake passage 11 opens into the cylinder bore 40 by piston-controlled inlet opening 26 which is controlled by the piston skirt 29 of the piston 23. The inlet opening 26 opens into and communicates with the crankcase 15. FIG. 3 shows the position of the piston 23 in which the inlet opening 26 upon upward stroke of the piston 23 begins to open. FIG. 3 shows a section plane through the internal combustion engine 10 that contains the longitudinal cylinder axis 16 and that is perpendicular to the axis of rotation 20 of the crankshaft 25 and to the longitudinal axis 35 of the piston pin 33. In this section plane, the bottom 36 of the intake passage 11 is the region that for any intake passage cross-section, i.e., in any cross-section perpendicular to the flow direction in the intake passage 11, has the smallest spacing to the crankcase 15. When the longitudinal cylinder axis 16 is arranged vertically and the crankcase 15 is arranged beneath the cylinder 14, a liquid droplet will flow across the bottom 36 in the direction toward the crankcase 15 until it reaches the ramp 28. The bottom 36 descends in the direction toward the crankcase 15. An imaginary extension 37 of the bottom 36 is positioned relative to the longitudinal cylinder axis 16 at an angle β which opens toward the combustion chamber 22 and is greater than 0° and smaller than 90°, i.e., is embodied as an acute angle.

The ramp 28 is arranged in the intake passage 11 immediately next to the inlet opening 26. In the section plane illustrated in FIG. 3, the ramp 28 extends in an arc shape and deflects the flow in the intake passage 11 to the piston 23. The ramp 28 has a top edge 31 at the inlet opening 26 which is the area with the smallest spacing to the combustion chamber 22. The imaginary tangential extension 32 of the ramp 28 at the top edge 31 intersects at an angle γ the longitudinal center axis 16 at a point of intersection 35 which, upon vertical arrangement of the longitudinal cylinder axis 16 and arrangement of the crankcase 15 beneath the combustion chamber 22, is located above the longitudinal axis 34 of the piston pin 33 and thus also above the outer circumference of the piston pin 33. The point of intersection 35 is approximately located at the top rim of the connecting rod 24 which is facing the piston bottom 51. The point of intersection 35 is positioned between the longitudinal axis 34 of the piston pin 33 and the combustion chamber 22. The point of intersection 35 has relative to the longitudinal axis 34 of the piston pin 33 a spacing a that is smaller than approximately 30% of a diameter d of the piston 23. The diameter d is measured next to the piston bottom 51 above a first piston ring 53. Advantageously, the spacing a is approximately 15% to approximately 25% of the diameter of the piston 23.

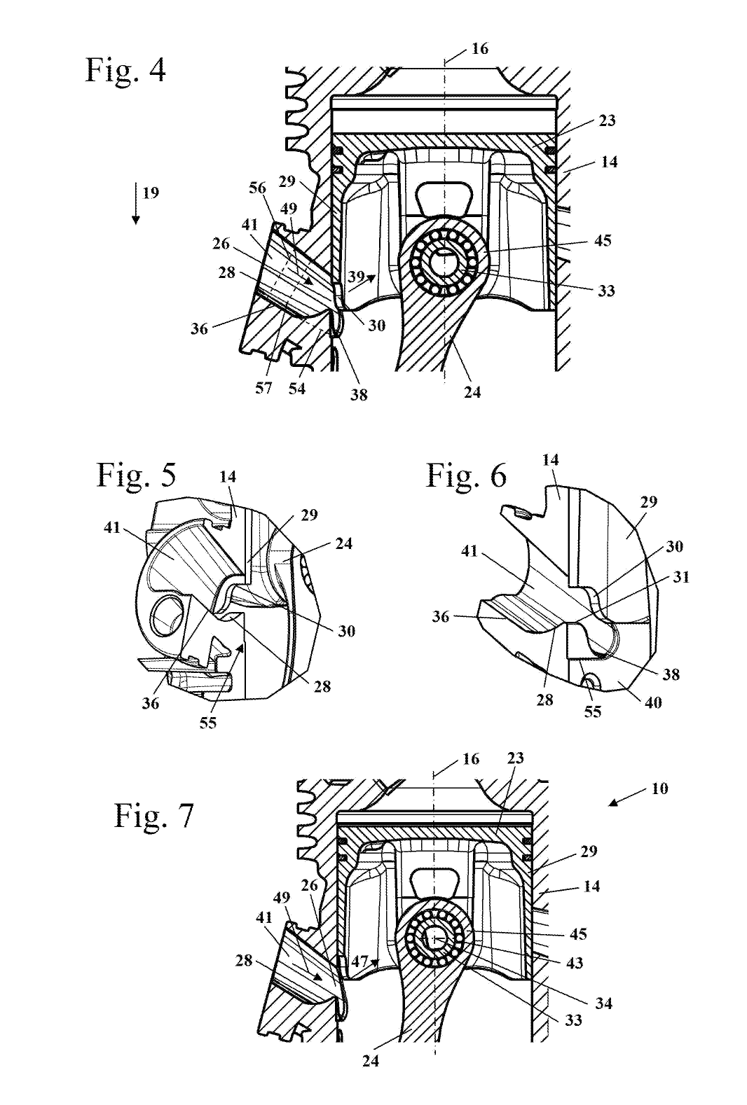

FIG. 4 shows the internal combustion engine 10 of FIG. 3 after further upward movement of the piston 23. The inlet opening 26 is almost open. In the intake section 41 of the intake passage 11 that is formed within the cylinder 14, the fuel/air mixture flows in flow direction 49. On the ramp 28, the mixture is deflected in the direction toward the piston 23 and flows in the interior of the crankcase 15 in flow direction 39 in the direction toward the bearing section 45 of the connecting rod 24. The bearing section 45 of the connecting rod 24 is the section of the connecting rod 24 in which the piston pin 33 is secured. The flow directions 49 and 39 are positioned advantageously at an angle that is approximately 30° to approximately 90°. Advantageously, the flow flowing in the flow direction 49 is deflected at the ramp 28 by more than 30°, in particular by more than 40°. The deflection angle about which the flow direction 49 is deflected is approximately the sum of the angles of the triangle of 180°-β-γ (FIG. 3).

FIG. 4 shows in an exemplary fashion two passage cross-sections 56 and 57 arranged perpendicularly to the flow direction 49. The bottom 36 is the connection of the points of the passage cross-sections 56 and 57 which in the park position 42 are located farthest downward relative to the direction of action 19 of the force of gravity, i.e., the lowermost points of the passage cross-sections 56, 57. In the park position 42 of the motor chainsaw 1, 21 (FIGS. 1 and 2), the bottom 36 is advantageously the connection of the lowermost points of all passage cross-sections 56, 57 that are positioned perpendicular to the flow direction and upstream of the ramp 28. In the illustration of FIG. 3, the bottom 36 has a transition 60 into the ramp 28. The transition 60 is the lowermost area of the intake section 41 of the intake passage 11. The bottom 36 extends upstream of the transition 60 along the extension of the intake passage 11, i.e., in flow direction 49. In case of a tubular configuration of the intake section 41 of the intake passage 11, the bottom 36 is the bottom side of the intake passage 11 extending in longitudinal direction of the intake section 41.

As shown also in FIG. 4, the piston skirt 29 of the piston 23 has a cutout 30 next to the inlet opening 26. The contour of the cutout 30 corresponds approximately to the contour of the ramp 28 when viewed in the direction from the interior of the cylinder toward the inlet opening 26. The contours of the cutout 30 and of the inlet opening 26 are shown in FIGS. 5 and 6. The cutout 30 is designed such that the inlet opening 26 first opens at the top edge 31 of the ramp 28 upon upward stroke of the piston 23. Only subsequently, the areas next to the top edge 31 are opened. As shown in FIGS. 4 and 6, the ramp 28 does not extend across the entire width of the inlet opening 26. Laterally arranged relative to the ramp 28 there is a drain 38 which, as indicated by dashed line 54 in FIG. 4, extends along an imaginary extension of the bottom 36. A drain 38 is provided also on that side of the ramp 28 that is not shown in FIGS. 4 to 6 and that is positioned in front of the section plane. By means of drain 38, fuel that has deposited on the wall of the intake passage 11 can drain into the interior of the crankcase 15. It is thus prevented that the fuel can collect between bottom 36 and ramp 28.

As seen in particular in FIG. 6, the ramp 28 is recessed minimally relative to the wall of the cylinder bore 40. Between the cylinder bore 40 and the ramp 28, a step 55 is formed on the wall of the cylinder bore 40. In this way, it is ensured that the piston 28 cannot get hooked on ramp 28 upon downward stroke of the piston 27.

FIG. 7 shows the internal combustion engine 10 during upward stroke of the piston 23 after complete opening of the inlet opening 26 and before reaching top dead center. The inflowing fuel/air mixture is deflected by the ramp 28 from the flow direction 49 in the intake section 41 of the intake passage 11 to a flow direction 47 in the interior of the crankcase 15. The flow direction 47 is oriented such that the fuel/air mixture is deflected toward the bearing section 45 of the connecting rod 24 and cools the bearing section 45. The connecting rod 24 is supported with a bearing 43 on the piston pin 33. The incoming fuel/air mixture cools and lubricates the bearing 43. In this context, the fuel/air mixture contains advantageously lubricant oil so that an excellent lubrication action is achieved. By cooling and lubricating the bearing 43 a long service life of the bearing 43 is achieved.

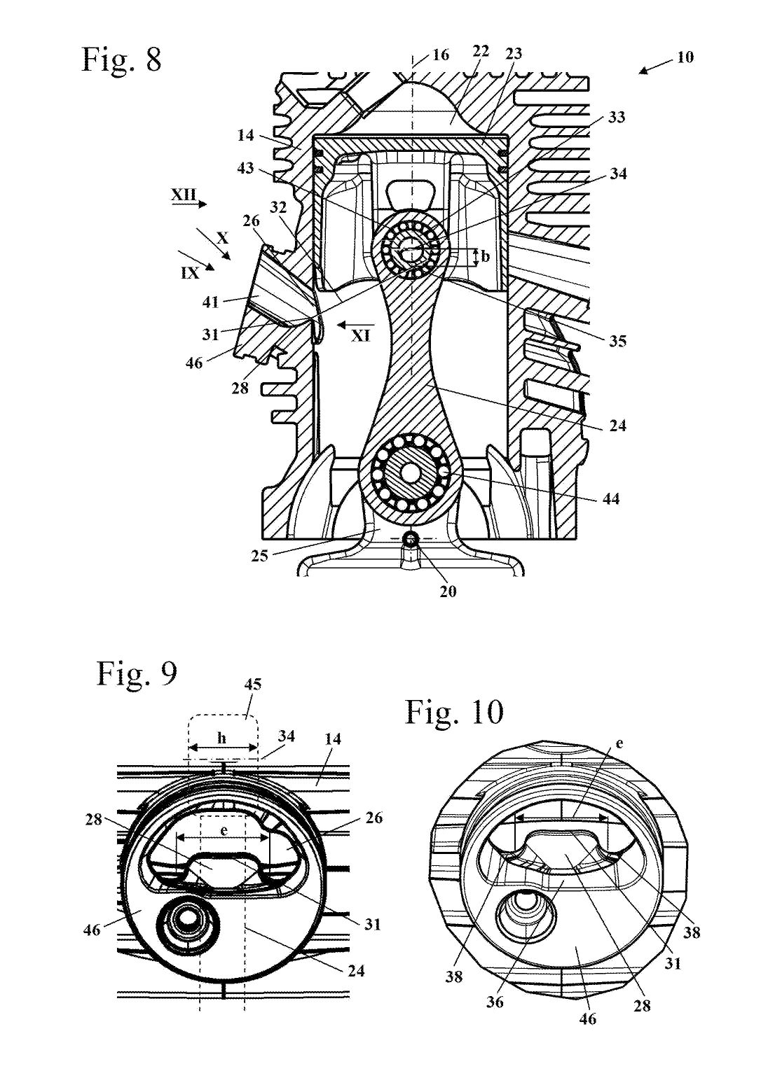

In FIG. 8, the internal combustion engine 10 is shown with piston 23 at top dead center. The point of intersection 35 in this position of the piston 23 has a spacing b to the longitudinal axis 34 of the piston pin 33 that is advantageously also less than 30% of the diameter of the piston 23. Advantageously, the spacing b is approximately 5% to approximately 25%, in particular approximately 10%, of the diameter d of the piston 23. The point of intersection 35 is positioned between the longitudinal axis 34 of the piston pin 33 and the axis of rotation 20 of the crankshaft 25. The point of intersection 35 is positioned accordingly on the side of the longitudinal axis 34 which is facing away from the combustion chamber 22. As also shown in FIG. 8, the intake section 41 of the intake passage 11 is formed in a cylinder flange 46.

FIGS. 9 and 10 show views of the cylinder flange 46 at different viewing angles. As indicated in FIGS. 9 and 10, the ramp 28 does not extend across the entire width of the inlet opening 26 but is arranged in a middle area of the inlet opening 26. A drain 38 is provided on either side of the ramp 28, respectively. The ramp 28 has a total width e, measured in circumferential direction of the cylinder bore 40 in a plane perpendicular to the longitudinal cylinder axis 16. In FIG. 9, the connecting rod 24 is schematically indicated. The connecting rod 24 has a width h at the bearing section 45 measured parallel to the longitudinal axis 34 of the piston pin 33; this width h is smaller than the total width e of the ramp 28. The total width e of the ramp 28 is advantageously at least approximately 80% of the width h of the connecting rod 24 at the bearing section 45.

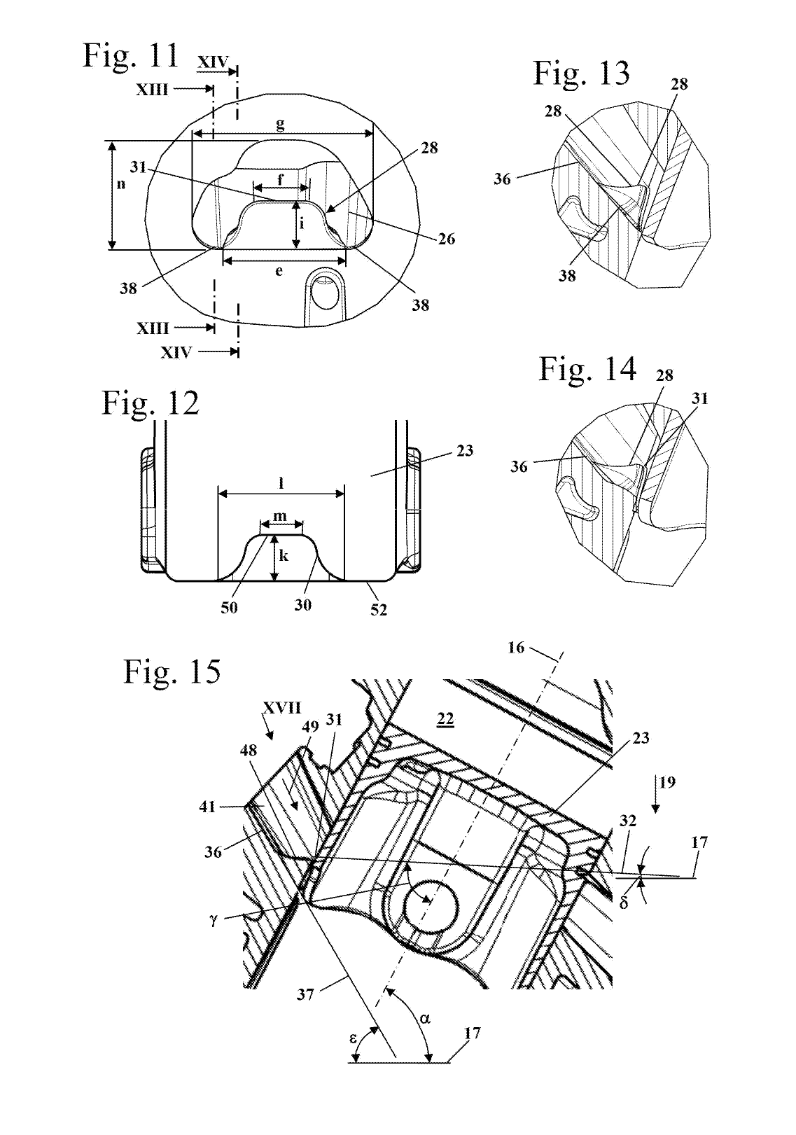

FIG. 11 shows the design of the ramp 28 in a viewing direction from the interior of the crankcase toward the inlet opening 26. The top edge 31 of the ramp 28 extends approximately in a plane that is perpendicular to the longitudinal cylinder axis 16. The top edge 31 has a width f which is significantly smaller than the total width g of the inlet opening 26. The total width g is also measured in circumferential direction of the cylinder bore 40 (FIG. 3) and in a plane perpendicular to the longitudinal cylinder axis 16. The total width e of the ramp 28 is significantly smaller than the total width g of the inlet opening 26. The width f of the top edge 31 is advantageously less than approximately 50% of the width g of the inlet opening 26. Advantageously, the width f is approximately 20% to approximately 30% of the width g. The total width e of the ramp 28 is advantageously less than approximately 80% of the width g of the inlet opening 26. Advantageously, the width e of the ramp 28 is approximately 50% to approximately 80% of the width g of the inlet opening 26. In FIG. 11, the height i of the ramp 28 measured parallel to the longitudinal cylinder axis 16 is also shown. Height i is measured parallel to the cylinder axis 16 at the top edge 31.

As also shown in FIG. 11, the inlet opening 26 has a height n which is measured parallel to the longitudinal cylinder axis 16. The height i of the ramp 28 is advantageously at least 20% of the height n of the inlet opening 26. Advantageously, the height i is approximately 25% to approximately 60%, in particular approximately 30% to approximately 50% of the height n.

FIG. 12 shows the configuration of the cutout 30 on the piston 23. The cutout 30 has a control edge 50 that controls the top edge 31 of the ramp 28. The piston 23 has a piston rim 52 that is facing the crankcase 15 and the control edge 50 has a spacing k relative to the piston rim 52 that is somewhat greater than the height i of the ramp 28. In this way, the inlet opening 26 first opens at the top edge 31. The area of the two drains 38 opens only subsequently toward the interior of the crankcase 15. In this way, an effective cooling of the piston 23 is ensured.

As also shown in FIG. 12, the cutout 30 on the piston 23 has a total width I. The total width I corresponds advantageously approximately to the total width e of the ramp 28. The total width I is advantageously approximately 90% to approximately 110% of the total width e. The control edge 50 has a width m which is advantageously approximately matches the width f of the top edge 31. The width m is advantageously approximately 80% to approximately 120% of the width f.

The course of a drain 38 is illustrated in FIG. 13. The drain 38 extends along an imaginary extension of the bottom 36 and descends at the same angle toward the interior of the crankcase 15 as the bottom 36. FIG. 14 shows a section of the ramp 28 in an area laterally located relative to the top edge 31.

FIG. 15 shows an embodiment of the internal combustion engine 10 arranged in a hand-guided power tool in such a way that the longitudinal cylinder axis 16 is positioned relative to the support surface 17, schematically indicated in FIG. 15, at an angle α that is approximately 45° to approximately 90°. Same reference characters as in the preceding Figures indicate corresponding elements. Advantageously, the angle α is at least 20%. The bottom 36 in intake section 41 of the intake passage 11 extends at a very steep angle. The imaginary extension 37 of the bottom 36 is positioned relative to the support surface 17 at an angle ε which is advantageously approximately 20° to approximately 90°. Advantageously, the angle ε is approximately 40° to 85°. Next to the bottom 36 in the intake section 41 of the intake passage 11, a ramp 48 is arranged that deflects the flow in the intake passage 11. In flow direction 49 the bottom 36 as well as the ramp 48 descend in the direction toward the interior of the crankcase. The imaginary extension 32 of the ramp 48 at the top edge 31 is positioned relative to the support surface 17 at an angle δ; the angle δ is greater than 0°. The angle δ can be, for example, approximately 1° to approximately 10°. The imaginary extension 32 is positioned relative to the longitudinal cylinder axis 16 at an angle γ which is from 0° to 90° and advantageously is approximately 45° to approximately 80°.

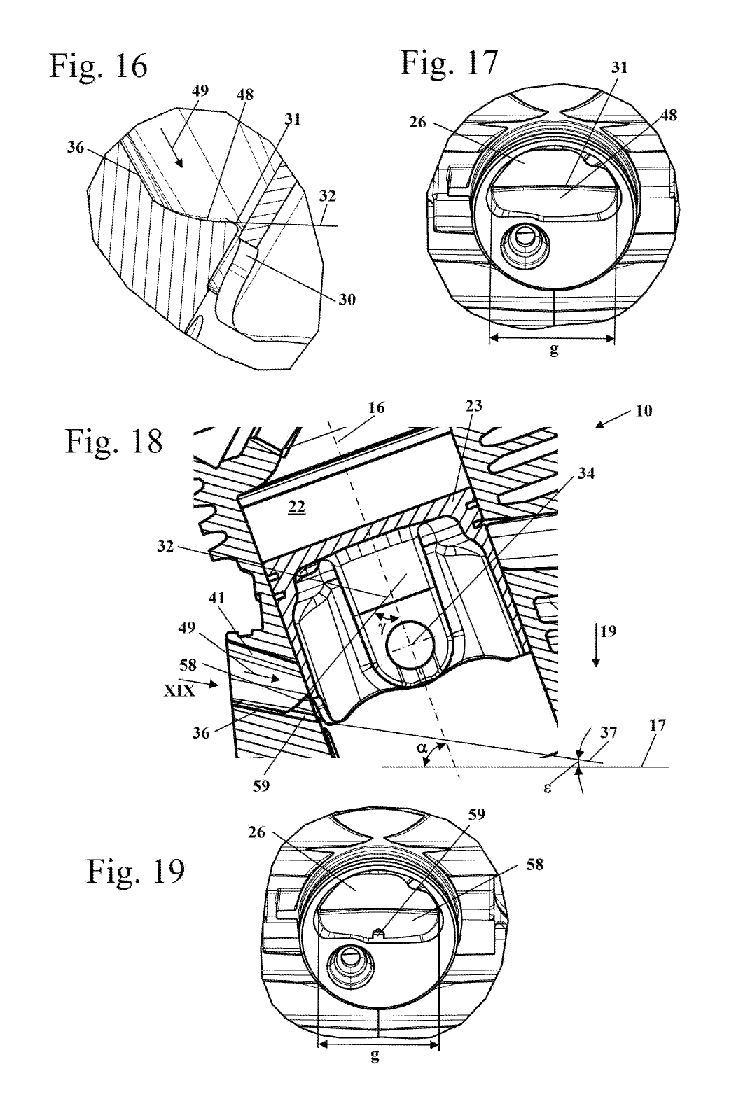

Since the ramp 48 descends in the direction toward the crankcase interior, the ramp 48 itself forms a drain for fuel. As illustrated also in the detail illustration of FIG. 16, the bottom 36 as well as the ramp 48 descend continuously in the direction toward the crankcase interior in the flow direction 49. Even though the ramp 48 is only slanted minimally relative to the support surface 17, collection of fuel can however still be avoided. As shown in FIG. 17, the ramp 48 extends across the entire width b of the inlet opening 26. It can also be provided that the ramp 48 extends parallel to the support surface 17. As a result of the flow flowing in the intake passage 11, collection of fuel can be avoided largely even for an approximately horizontal arrangement of the ramp 48.

In the embodiment according to FIGS. 18 to 20, a drain 59 is provided that is designed as an opening in the ramp 58. The ramp 58 is designed in accordance with the embodiment of the ramp 48 and has a width g that corresponds to the width of the inlet opening 26. The internal combustion engine 10 is arranged in a hand-guided power tool in such a way that the bottom 36 in the park position 42 (FIGS. 1 and 2) descends in the direction toward the crankcase 15. The ramp 58 however ascends steeply in the flow direction 49. In order to ensure that fuel will not collect between bottom 36 and ramp 58, drain 59 is provided that is designed as a bore or channel through the ramp 58. The drain 59 extends along an imaginary extension of the bottom 36 and is positioned relative to the support surface 17 at an angle ε that is greater than 0°. The drain 59 descends in the park position 42 toward the interior of the crankcase 15. It is also possible that several bores or channels are provided that form the drain 59.

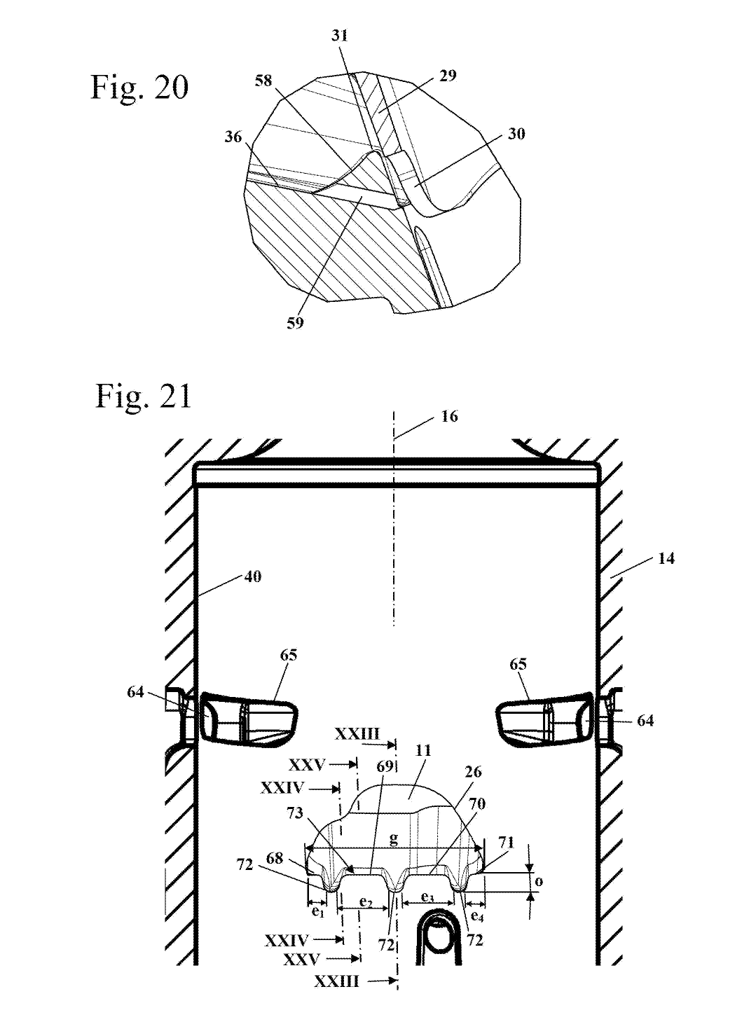

As shown in the illustration of FIG. 20, the drain 59 upon upward stroke of the piston 23 opens before the inlet opening 26 opens at the top edge 31. This is so because of the arrangement of the drain 59 in the area of the cutout 30. Alternatively, it can also be provided that the drain 59 is arranged outside of the area that is controlled by the cutout 30. In this way, it can be achieved that the drain 59 will connect with the interior of the crankcase 15 only at the point in time when the inlet opening 26 at the top edge 31 is communicates with the interior of the crankcase 15.

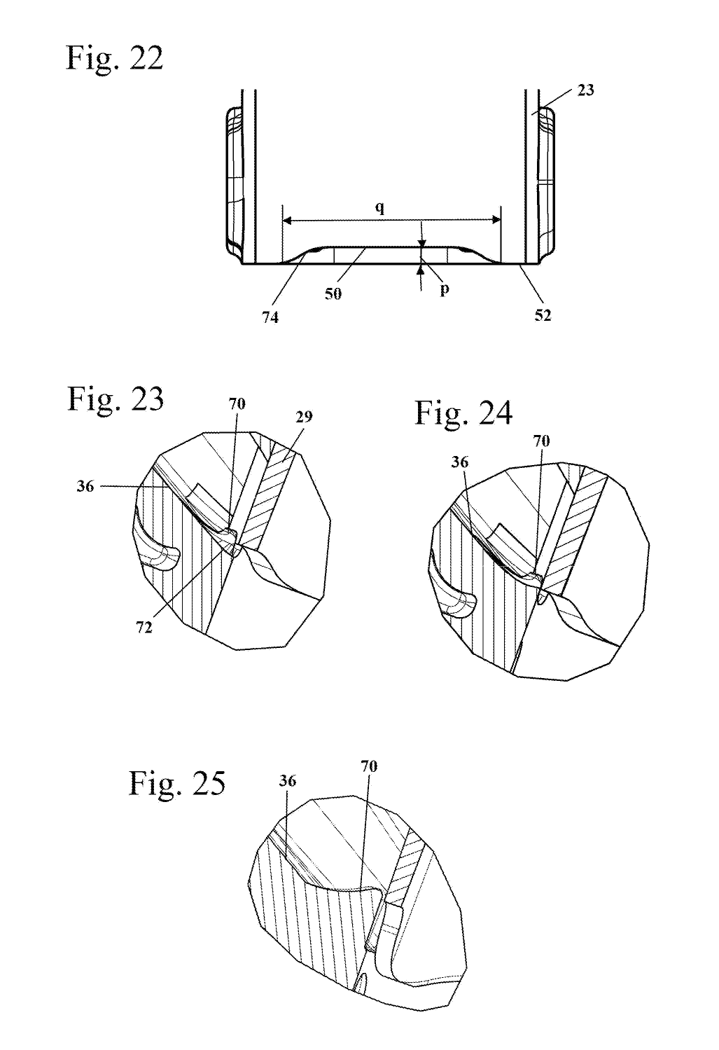

FIGS. 21 to 25 show an embodiment of an internal combustion engine 10; FIG. 21 shows the cylinder 14, and FIG. 22 shows the piston 23 of the internal combustion engine 10.

As shown in FIG. 21, in the intake passage 11 next to the inlet opening 26 a total of four ramps 68, 69, 70, 71 are formed. A drain 72 is provided between the ramps 68, 69, 70, 71, respectively. The ramps 68 and 71 have a significantly smaller width than the middle ramps 69 and 70 and have a transition at the outwardly positioned side (in circumferential direction) from their top edge 73 into the wall of the inlet opening 26.

In the embodiment illustrated in FIGS. 21 to 25, the total width e of the ramps 68, 69, 70, 71 is less than approximately 80% of the width of the inlet opening measured in circumferential direction of the cylinder bore. The total width e of the ramps 68, 69, 70, 71 is the sum of the widths e₁, e₂, e₃, e₄ of the ramps 68, 69, 70, 71 shown in FIG. 21. Also, the orientation of the ramps 68, 69, 70, 71 relative to the piston 23 and to the longitudinal cylinder axis 16 corresponds to the orientation that has been discussed in connection with the other embodiments. Same reference characters characterize in all Figures elements that correspond to each other.

As shown in FIG. 22, the piston 23 has a cutout 74 whose width q advantageously matches at least the width g of the inlet opening 26 illustrated in FIG. 21, advantageously it is somewhat greater than it. The ramps 68, 69, 70, 71 have a height o that is measured parallel to the longitudinal cylinder axis 16 and that is significantly smaller than the height n of the inlet opening 26 illustrated in FIG. 11. A control edge 50 is formed on the cutout 74 and extends approximately perpendicular to the longitudinal cylinder axis 16 (FIG. 21); the spacing p (illustrated in FIG. 22) of the control edge 50 relative to the piston rim 52 corresponds advantageously at least to the height o of the ramps 68, 69, 70, 71. Since all ramps 68 to 71 are controlled by control edge 50 which is extending continuously in a plane perpendicular to the longitudinal cylinder axis 16, the drains 72 open before the inlet opening 26 will open in the area of the ramps 68 to 71.

FIGS. 23 to 25 show different section views of the internal combustion engine 10 in the area of the inlet opening 26. As shown in FIG. 23, the drain 72 extends along an imaginary extension of the bottom 26. Advantageously, all drains 72 extend along imaginary extensions of the upstream section of the wall of the intake passage 11. As shown in FIG. 25, like ramp 28, the ramp 70 extends in flow direction also in a curve. The ramps 69, 70 and 71 are advantageously correspondingly designed.

The specification incorporates by reference the entire disclosure of German priority document 10 2012 023 166.0 having a filing date of Nov. 28, 2012.

While specific embodiments of the invention have been shown and described in detail to illustrate the inventive principles, it will be understood that the invention may be embodied otherwise without departing from such principles.

What is claimed is:

1. A power tool comprising:
an internal combustion engine;
at least one tool member connected to the internal combustion engine so as to be driven by the internal combustion engine;
the internal combustion engine having a cylinder with a longitudinal cylinder axis, wherein the cylinder has a cylinder bore;
the internal combustion engine having a piston reciprocatingly supported in the cylinder bore and delimiting a combustion chamber in the cylinder;
a crankcase connected to the cylinder;
a crankshaft rotatably supported about an axis of rotation within the crankcase and connected to the piston so as to be driven in rotation by the piston;
the internal combustion engine having an intake passage through which combustion air is supplied;
the intake passage having a piston-controlled inlet opening that communicates with the crankcase;
the intake passage having an intake section formed within the cylinder;
the intake section having a bottom;
the bottom, when the longitudinal cylinder axis is vertically positioned and the crankcase is arranged beneath the combustion chamber, connecting lowermost points of at least two passage cross-sections that are arranged in the intake section of the intake passage perpendicular to the flow direction;
the bottom descending toward the crankcase when the longitudinal cylinder axis is vertically positioned;
a ramp arranged in the intake passage next to the inlet opening, wherein the ramp deflects at least a portion of a flow flowing within the intake passage;
the ramp, when the longitudinal cylinder axis is vertically positioned, ascending in the flow direction toward the crankcase at least within a ramp section that is adjoining the inlet opening.

2. The power tool according to claim 1, having a customary park position in which the power tool is placed on a flat horizontal support surface.

3. The power tool according to claim 2, wherein the longitudinal cylinder axis in the park position is positioned at an angle relative to the support surface that is approximately 60° to approximately 90°.

4. The power tool according to claim 2, wherein the bottom of the intake passage arranged upstream of the ramp is not ascending in the flow direction toward the crankcase in the park position.

5. The power tool according to claim 1, wherein the internal combustion engine comprises a connecting rod and the piston is connected by a piston pin to the connecting rod, wherein the piston pin has a longitudinal axis, wherein the ramp has a top edge at the inlet opening, and wherein an imaginary tangential extension of the ramp at the top edge intersects the longitudinal cylinder axis at a point of intersection.

6. The power tool according to claim 5, wherein, at top dead center of the piston, a spacing of the point of intersection relative to the longitudinal axis of the piston pin is at most approximately 30% of the diameter of the piston.

7. The power tool according to claim 5, wherein, at top dead center of the piston, the point of intersection is positioned between the axis of rotation of the crankshaft and the longitudinal axis of the piston pin.

8. The power tool according to claim 5, wherein, in a position of the piston in which the inlet opening begins to open, a spacing of the point of intersection relative to the longitudinal axis of the piston pin is smaller than approximately 30% of the diameter of the piston.

9. The power tool according to claim 5, wherein, in a position of the piston in which the inlet opening begins to open, the point of intersection is positioned between the longitudinal axis of the piston pin and the combustion chamber.

10. The power tool according to claim 5, wherein a total width of the ramp is at least approximately 80% of a width of the connecting rod measured parallel to the longitudinal axis of the piston pin in a bearing section of the connecting rod that surrounds the piston pin.

11. The power tool according to claim 5, wherein a total width of the ramp measured in a circumferential direction of the cylinder bore is less than approximately 150% of a width of a bearing section of the connecting rod that surrounds the piston pin and is measured parallel to the longitudinal axis of the piston pin.

12. The power tool according to claim 5, wherein a total width of the ramp measured in a circumferential direction of the cylinder bore is less than approximately 80% of a width of the inlet opening measured in the circumferential direction to the cylinder bore.

13. The power tool according to claim 5, wherein a width of the ramp at the top edge measured in a circumferential direction of the cylinder bore is less than approximately 50% of a width of the inlet opening measured in the circumferential direction of the cylinder bore.

14. The power tool according to claim 5, wherein the inlet opening opens first at the top edge when the piston carries out an upward stroke.

15. The power tool according to claim 14, wherein the piston has a control edge in an area that is controlling the top edge and further has a piston rim that is facing the crankcase, wherein the control edge has a spacing to the piston rim, wherein the spacing is greater than a height of the ramp measured at the top edge parallel to the longitudinal cylinder axis.

16. The power tool according to claim 2, wherein at the inlet opening a drain for fuel is provided which descends in the flow direction toward the crankcase in the park position.

17. The power tool according to claim 16, wherein two of said drain are provided on opposite sides of the ramp.

18. The power tool according to claim 16, wherein the drain is a channel that extends through the ramp.

19. The power tool according to claim 1, wherein several of said ramp are arranged in the intake passage next to the inlet opening.
